(19) United States
(12) Patent Application Publication
(10) Pub. No.: US 2013/0311193 A1
(43) Pub. Date: Nov. 21, 2013

(54) MEDICAL MONITORING RULE RECOMMENDATION

(71) Applicants: YooJin Know, Seoul (KR); HeonKyn Park, Seoul (KR); Haggai Roitman, Yoknea'm Elit (IL)

(72) Inventors: YooJin Know, Seoul (KR); HeonKyn Park, Seoul (KR); Haggai Roitman, Yoknea'm Elit (IL)

(73) Assignee: International Business Machines Corporation, Armonk, NY (US)

(21) Appl. No.: 13/447,219

(22) Filed: May 15, 2012

(51) Int. Cl. G06Q 50/22

(52) U.S. Cl. 705/2

(57) ABSTRACT

Method, system, and computer program product are provided for medical monitoring rule recommendation for a medical records system. The method includes: indexing previously generated medical monitoring rules to provide a rules index; and determining rule features by evaluating previously generated medical monitoring rules based on existing patient data. The method further includes: receiving a given patient's data; querying the given patient's data in the rules index to provide candidate rules; and scoring the candidate rules based on the rule features including the frequency a rule was satisfied for existing patients. Scoring the candidate rules may also includes scoring based on the given patient's data by executing a candidate rule on the given patient's data.

### BACKGROUND

This invention relates to the field of medical monitoring. In particular, the invention relates to medical monitoring rule recommendation.

Monitoring patients' medical conditions is one of the fundamental aspects for realizing smart-health and patient empowerment services. Such monitoring is usually based on medical rules, continuously evaluated over patient personal health record (PHR) data in order to provide timely alerts to patients and health practitioners so preventative actions can be taken. For example, a diabetic patient may be assigned with medical monitoring rules which monitor her sugar levels, and timely alerts are provided every time the sugar level exceeds some threshold.

Patient empowerment systems have been developed in order to integrate patient health information across medical institutions and practitioners and patients. For example, patient empowerment systems include: IBM Patient Empowerment System (IBM is a trade mark of International Business Machines Corporation), and IBM Medics (IBM Medics is a trade mark of International Business Machines Corporation).

Patient empowerment systems may provide means to define medical monitoring rules over a given patient's PHR data. Such rules can be then shared with the rest of the patient community and their health providers for the benefit of others who may wish to utilize the generated rules.

There is an ever-increasing amount of PHR data being monitored and a correspondingly increasing number of user-generated medical monitoring rules.

### BRIEF SUMMARY

According to a first aspect of the present invention there is provided a computer-implemented method for medical monitoring rule recommendation performed by a computerized device having a processor, comprising: indexing previously generated medical monitoring rules to provide a rules index; determining rule features by evaluating previously generated medical monitoring rules based on existing patient data; receiving a given patient's data; querying the given patient's data in the rules index to provide candidate rules; and scoring the candidate rules based on the rule features including the frequency a rule was satisfied for existing patients.

According to a second aspect of the present invention there is provided a computer program product for medical monitoring rule recommendation, the computer program product comprising: a computer readable non-transitory storage medium having computer readable program code embodied therewith, the computer readable program code comprising: computer readable program code configured to: index previously generated medical monitoring rules to provide a rules index; determine rule features by evaluating previously generated medical monitoring rules based on existing patient data; receive a given patient's data; query the given patient's data in the rules index to provide candidate rules; and score the candidate rules based on the rule features including the frequency a rule was satisfied for existing patients.

According to a third aspect of the present invention there is provided a system for medical monitoring rule recommendation, comprising: a processor; an existing rules processing component including: a rule indexer component for indexing previously generated medical monitoring rules to provide a rules index; a rule features component for determining rule features by evaluating previously generated medical monitoring rules based on existing patient data; a recommendation component including: a patient data receiving component for receiving a given patient's data; a rule lookup component for querying the given patient's data in the rules index to provide candidate rules; and a rule static scorer component for scoring the candidate rules based on the rule features including the frequency a rule was satisfied for existing patients.

According to a fourth aspect of the present invention there is provided a method of providing a service to a customer over a network for medical monitoring rule recommendation, the service comprising: indexing previously generated medical monitoring rules to provide a rules index; determining rule features by evaluating previously generated medical monitoring rules based on existing patient data; receiving a given patient's data; querying the given patient's data in the rules index to provide candidate rules; and scoring the candidate rules based on the rule features including the frequency a rule was satisfied for existing patients.

### BRIEF DESCRIPTION OF THE SEVERAL VIEWS OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a schematic diagram of a graphical user interface in accordance with an aspect of the present invention;

FIG. 2 is a schematic diagram of a graphical user interface in accordance with a further aspect of the present invention;

FIG. 3 is a flow diagram of a method in accordance with the present invention;

FIG. 4 is a flow diagram of an aspect of a method in accordance with the present invention;

FIG. 5 is a flow diagram of a further aspect of a method in accordance with the present invention;

FIG. 6 is a block diagram of a system in accordance with the present invention; and

FIG. 7 is a block diagram of a computer system in which the present invention may be implemented.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Method, system and computer program product are described in which a recommendation service is provided in the context of a computerized medical records system. Computerized medical records systems store patients' personal health records (PHR) and may also include sets of medical monitoring rules associated with each patient. The medical monitoring rules may be evaluated over a patient's personal health record (PHR) data in order to provide timely alerts to patients and health practitioners of conditions in which preventative actions should be taken.

In the described recommendation service, given a patient's PHR data, the PHR data of other patients in the system and the set of medical monitoring rules associated with each existing patient, existing medical monitoring rules are recommended to apply to the given patient's PHR data.

The recommendation service may automatically recommend rules for monitoring a patient based on previously generated rules while considering quality factors such as: past rule execution outcomes, potential execution outcome for a current patient's PHR data, the frequency with which a rule is satisfied, the severity of medical condition detected by a rule.

The recommendation service may estimate rule quality based on the combination of historical data from other patients and existing medical data of the current recommended patient prior to rule execution. In addition, quality measures are proposed for rule execution (e.g., frequency and rate of change, knowledge score).

An example embodiment of a medical monitoring rule is now defined. Let R denote a medical monitoring rule. Each medical rule may contain the following properties:

1. Name: rule name.
2. Description: free-text description that describes the rule.
3. Condition: an expression that describes the rule condition.

The expression may be a list of simple predicates P combined together using Boolean operators.

Each predicate P may be of the form “medEntityType.medEntityAttribute Op Value” where:
medEntityType is a type of medical entity (e.g., PatientInfo, Medication, Allergy, . . . );
medEntityAttribute is a name of some attribute (e.g., doseQuantity for Medication entity);
Op is comparison operator, (e.g., >, <, =);
Value is a threshold for predicate satisfiability.
   4. Action: an action to perform given that the rule condition is satisfied, e.g., alert with some message, event, etc.

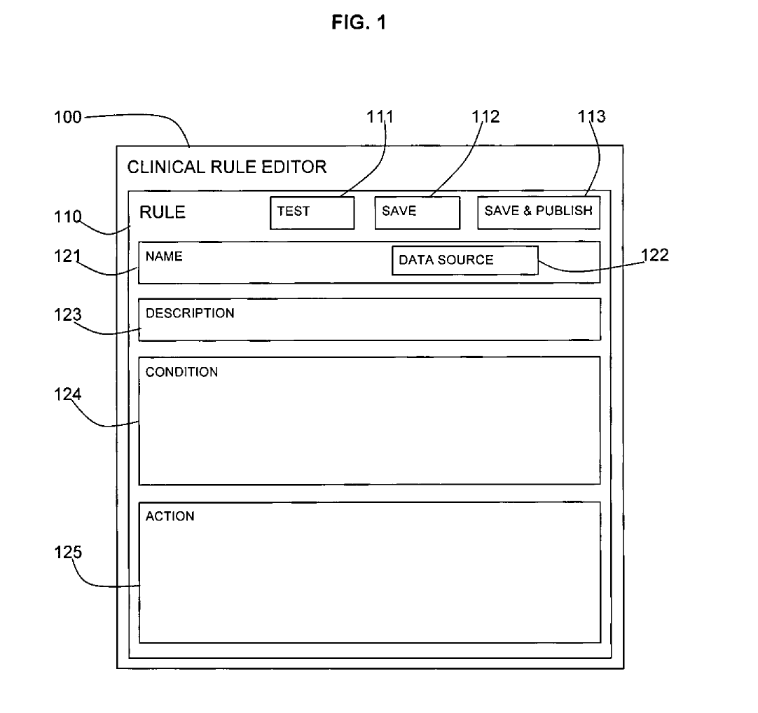

Referring to FIG. 1, an example graphical user interface (GUI) 100 of a clinical rule editor is shown for providing and editing medical monitoring rules for a patient in a computerized medical records system.

The GUI 100 shows a window 110 in which a rule may be defined with options to test 111, save 112, or save and publish 113 the input rule. A rule may have a name section 121 for input in which a name for the rule may be provided. A data source section 122 may be provided for referencing or attaching a data record. A description section 123 may be provided in which free text may describe the rule. A user may also add a message in the description section 123.

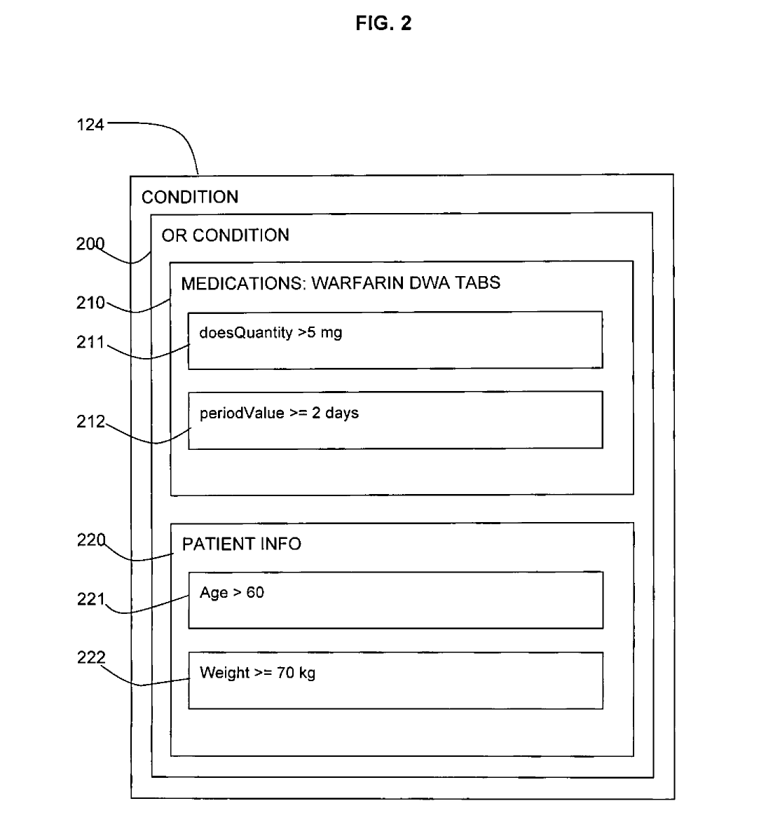

A condition section 124 may be provided in which an expression may be defined which describes the rule. Further details of this condition section are shown in relation to FIG. 2. An action section 125 may be provided to define the action taken if the condition of the condition section 124 is satisfied.

Referring to FIG. 2, an example condition definition 200 of the condition section 124 of the GUI 100 of FIG. 1 is shown for an OR condition definition. A first condition requirement is provided for medications 210 (in this example, Warfarin DWA tablets) with a dose 211 “doseQuantity >5 mg” and a time period 212 “periodValue >=2 days” defined. A second condition requirement is provided for patient information 220 as having a given age 221 “age >60” and a given weight “weight >=70 kg”.

The condition definition 200 has an OR operator and therefore, the condition reads as follows:

IF patients consumed Warfarin DWA TABS medication with dosage quantity above 5 mg and period value exceeded 2 days OR patient age is above 60 and weight is above 70 kg, then the condition is met.

An alert may then be specified which may be carried out if the condition is met.

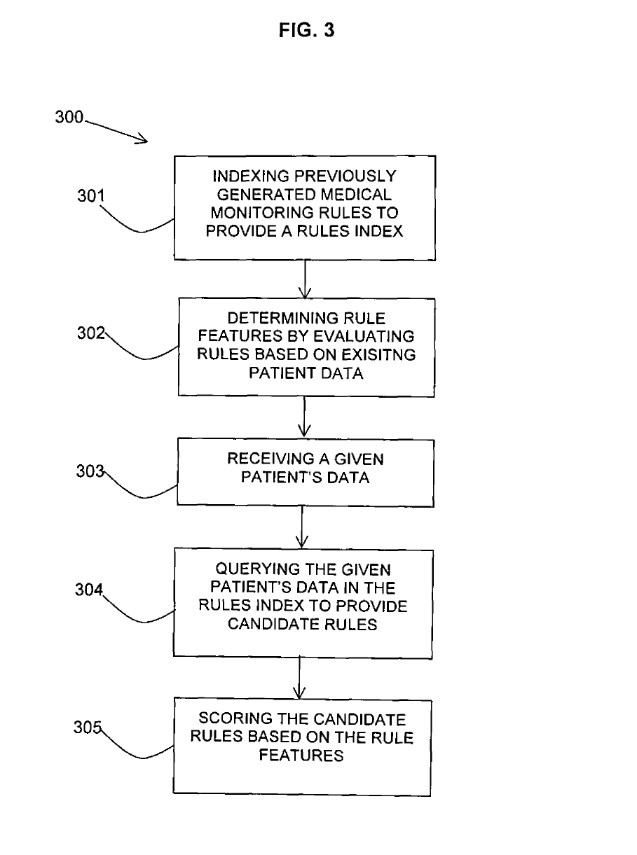

Referring to FIG. 3, a flow diagram 300 shows an embodiment of the described method. A method for medical monitoring rule recommendation may be performed by a computerized device. Previously generated medical monitoring rules may be indexed 301 to provide a rules index, for example, from an existing medical records system. Rule features may be determined 302 by evaluating the previously generated medical monitoring rules based on existing patient data, for example, in the form of PHRs in the medical records system.

The method may receive 303 a given patient's data, for example, in the form of a new patient for which monitoring rules are required to be recommended. The given patient's data may be used to query 304 the rules index to provide candidate rules for the given patient. The candidate rules may be scored 305 based on the rule features including the frequency a rule was satisfied for existing patients.

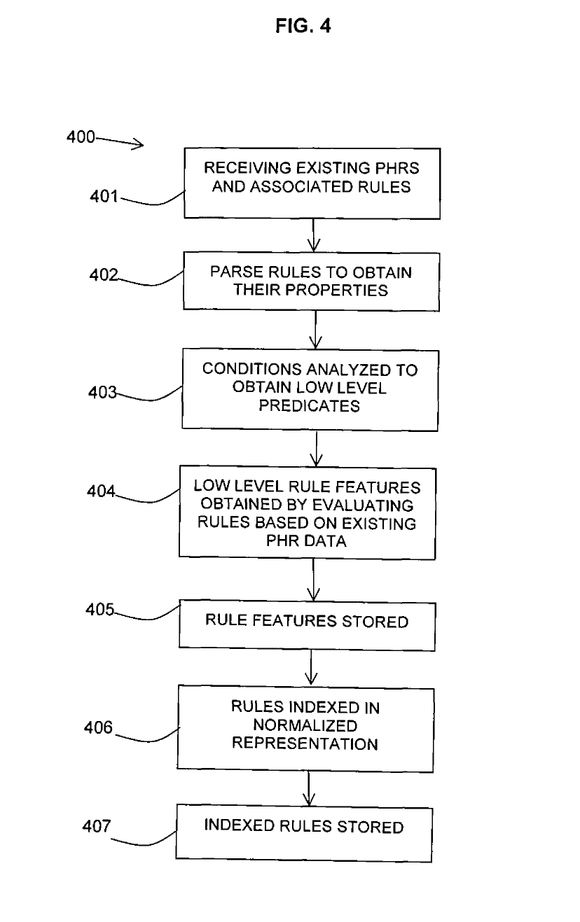

Referring to FIG. 4, a flow diagram 400 shows further details of an aspect of the described method carried out by a recommendation service of processing existing medical monitoring rules as providing in a medical records system for patients PHR data.

Existing PHRs and associated rules are input and received 401 by the recommendation service. The rules are parsed 402 to obtain their properties. In particular, the condition part of a rule is analyzed and low level predicates are obtained 403, for example, by breaking a Boolean expression into its basic parts such as P1 OR P2→{P1,P2}. Low level rule features are obtained 404 by evaluating the rules based on existing PHR data in the system.

Therefore, for each predicate P, the following features may be obtained:

1. np(P): the number of patients which has this predicate in one of their rules.
2. freq(P): by evaluating the predicate on the existing PHRs, how many times this predicate was observed as satisfied.

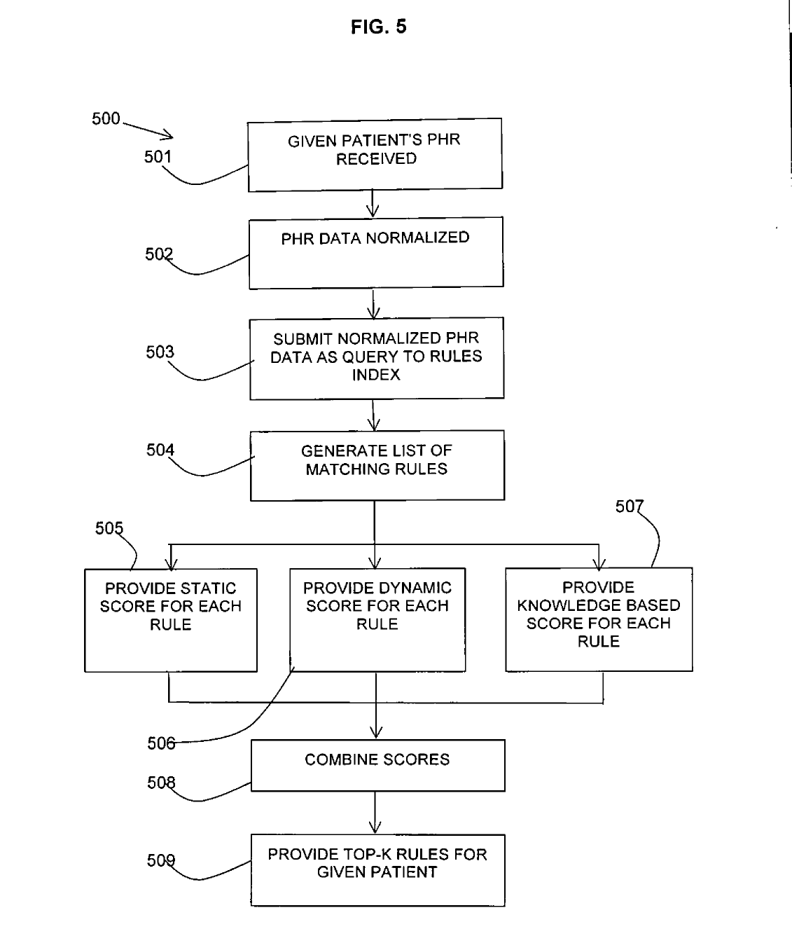

The rule features may be stored 405 for use later on to assign a static score to a matching rule during recommendation (described in relation to FIG. 5).

A rule may then be indexed 406 by representing the rule in a normalized way. The indexed rules may be stored 407 in a rules index which enables the rules to be searched later on and matched with other patients' PHR data.

Referring to FIG. 5, a flow diagram 500 shows further details of an aspect of the described method carried out by a medical monitoring rules recommendation service for a medical records system.

A given patient's PHR data is input and received by the recommendation service 501. The PHR data may be normalized 502 and represented as a simple rule predicate P with medEntityType as the entity's type, medEntityAttribute as the entity's attribute name, and Value as its value, further assigning Op to be =. For example, a medication with brand name Warfarin will be represented as the simple predicate:
Medication.brand_name=Warfarin.

The normalized PHR data representation may be submitted 503 as a query to a rules index as generated from the existing rules processing as described in step 407 of FIG. 4. A list of potentially matching, candidate rules may be generated 504.

The next stage is to assign scores to the generated rules. A static score may be provided 505 based the existing rule features. A personalized score may be obtained 506 by executing the rule on the given patient's PHR data (as input in step 501) to obtain a “dynamic” relevance score. A knowledge score may be provided 507 for the rule given that it is satisfied. Such a knowledge score, for example, can be based on the severity of the medical condition being detected by the rule.

The different scores of the rule may then be combined 508 and a top-k rules are provided 509 having the highest scores for the given patient PHR.

User feedback on the rules (for example, from physicians, or researchers) may be received and processed to provide further data for scoring the rules.

Further example details of the rule scoring are now provided.

### Static Score

A static score may capture the usefulness of a rule based on existing PHR rules data. An example of a static rule score may be determined as follows. It is assumed that predicates are represented in disjunctive normal form (DNF); however, if conjunctive normal form (CNF) form is used, the score is obtained by multiplication of predicate scores.
Given that rule R has predicates P1, P2, . . . , Pk:

Score_{—}s(R)=\sum_{—}{Pi}Score_{—}s(Pi)
where:

Score_{—}s(Pi)=log(freq(Pi))*log(np(P)) and N is the total number of patients in the system.

Therefore, a relevant rule that has many patients who use it and is more frequently satisfied is preferred.

Another possible static score is based on the ratio between true positive and false positive of the rule execution based on existing PHR data records of other patients; i.e., a more qualitative rule is such that it has high a true positive detection rate and low false positive rate.

ROC (Receiver operating characteristic) data may be obtained by getting feedback from expert users (e.g., physicians, researchers) about the number of cases where the rule correctly detected a true problem (true positive) compared to its false positive.

### Dynamic Score

A dynamic score captures the usefulness of a rule for the specific patient in mind, based on the input PHR. This may be done by actively executing the rule R on the given PHR data.
Let freq(R) denote the number of times the rule was satisfied given the PHR data.
Then:

Score_{—}d(R|PHR)=log(lambda+freq(R)) where lambda is a parameter that defines a threshold for initial consideration.
For example, with lambda=1, if freq(R)=0 than this rule will be pruned from recommendation since it is not satisfied at all given the PHR data.

Another aspect of dynamic scoring may be based on the similarity of the given patient's data with the patients' data of the set of existing patients associated with the rule being scored (e.g., average similarity patient-wise). This may be applied as part of the dynamic scoring or may be used to boost further a rule's final score for recommendation during the score combining

### Knowledge Score

A third score, termed “knowledge score” may be used to obtain a knowledge based score for the rule given that it is satisfied. Such a score, for example, can be based on the severity of the medical condition being detected by the rule. For example, a rule about an Adverse Drug Event (ADE) detects a more sever phenomenon than a rule about obesity. As another example, a rule that detects high blood sugar levels given a diabetic patient in mind is more important than a rule that detects low haemoglobin levels.
Let Score_kb(R) denote this score.

### Score Combining

The three scores may be combined as follows:

Score(R|PHR)=[\alpha*Score_{—}s(R)+(1−\alpha)Score_{—}d(R|PHR)]*Score_{—}kb(R)

The existing rules in the rules index may be restricted based on the similarity of the given patient's PHR and the existing patients' PHR. Rules associated with the similar existing patients may be selected which may then be queried for the given patient's PHR as in step 503 of FIG. 5.

Alternatively, all indexed rules may be used and patient similarity may be used as one feature in the ranking function of the recommended rules.

It may be possible to write rules in a more detailed way that would make them more accurate. Authored rules may sometimes be too simple and defined by people maybe skilled in medicine but not rule management. A recommendation rule feedback mechanism may be provided to provide users' feedback on the rule pattern they just defined based on rule similarity.

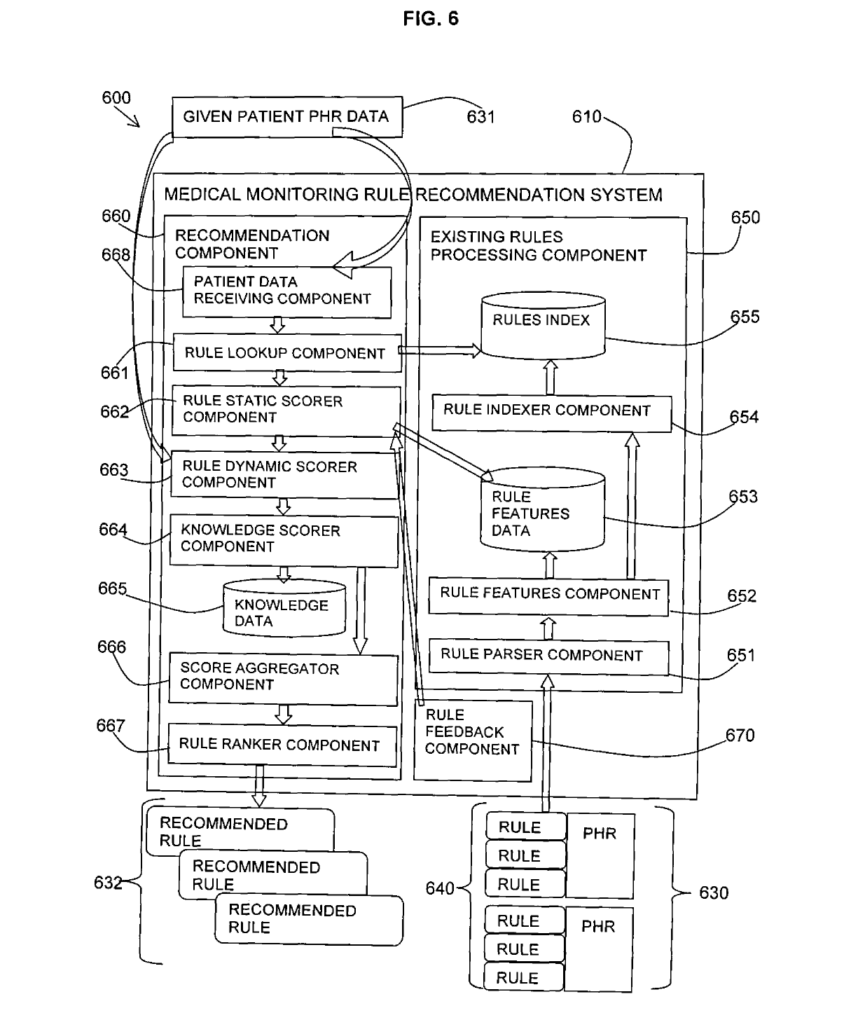

Referring to FIG. 6, an example embodiment of the described system 600 is shown including a medical monitoring rule recommendation system 610.

A medical monitoring rule recommendation system 610 may be provided as part of a computerized medical records system or as an auxiliary system to be used in conjunction with a computerized medical records system with locally or provided over a network.

A plurality of PHRs 630 may be provided with active medical monitoring rules 640, wherein multiple medical monitoring rules 640 may be defined for each PHR 630. The PHR 630 and rule 640 data may be stored in a computerized medical records system (not shown) and accessed by the recommendation system 610.

The recommendation system 610 may include an existing rules processing component 650. The existing rules processing component 650 may include a rule parser component 651 for parsing the existing rules to obtain their properties. A rule features component 652 may be provided for obtaining low level rule features by evaluating the rules based on existing PHR data in the system. The rules features data 653 may be stored in a data storage medium. For example, for each predicate P, the following features may be stored:

1, np(P): the number of patients which has this predicate in one of their rules.
2. freq(P): by evaluating the predicate on the existing PHRs, how many times this predicate was observed as satisfied.

The existing rules processing component 650 may also include a rule indexer component 654 for representing each rule in a normalized way, which enables the rule to be searched later on and matched to other patients PHR data. The rules index 655 may be stored in a data storage medium.

The recommendation system 610 may include a recommendation component 660 including a patient data receiving component 668 for receiving as an input a given patient PHR data 631 for which medical monitoring rules are to be recommended.

The recommendation component 660 may include a rule lookup component 661 which may represents each medical entity in the PHR data as a simple rule predicate P, with medEntityType as the entity's type, medEntityAttribute as the entity's attribute name and Value as its value, further assigning Op to be =.

The rule lookup component 661 may submit the normalized PHR data representation as a query to the rules index data 655, to obtain a list of potentially matching rules. In one embodiment, the rule index data 655 may be restricted for a query based on a given patient's PHR data 631 to rules associated with existing patients who have PHR data similar to the given patient's PHR data 631.

A rule static scorer component 662 may be provided for assigning scores to rules based on the existing rule features data 653 to capture the usefulness of a rule based on existing PHR rules data.

The rule static scorer component 662 may process expert user feedback as input into a rule feedback component 670 of the medical monitoring rule recommendation system 610 to provide ROC (Receiver operating characteristic) data about the number of cases where the rule correctly detected a true problem (true positive) compared to its false positive as an aspect of the static score.

A rule dynamic scorer component 663 may be provided for generating a dynamic score by executing the rule on the given patient's PHR data 631. This captures the usefulness of a rule for the specific patient in mind.

The rule dynamic scorer component 663 may determine a similarity between the given patient's PHR data and patients' data of the set of existing patients associated with the rule being scored (e.g., average similarity patient-wise).

A knowledge scorer component 664 may be provided for generating a knowledge score based on stored medical knowledge data 665.

A score aggregator component 666 may be provided to combine the generated scores for each rule.

A rule ranker component 667 may be provided for outputting the top-k recommended rules 632 with the highest scores.

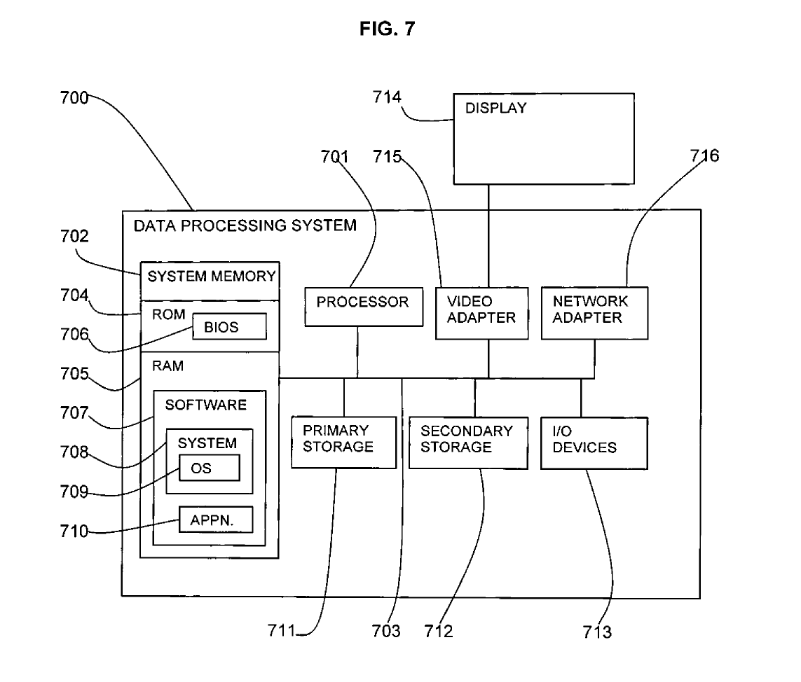

Referring to FIG. 7, an exemplary system for implementing aspects of the invention includes a data processing system 700 suitable for storing and/or executing program code including at least one processor 701 coupled directly or indirectly to memory elements through a bus system 703. The memory elements can include local memory employed during actual execution of the program code, bulk storage, and cache memories which provide temporary storage of at least some program code in order to reduce the number of times code must be retrieved from bulk storage during execution.

The memory elements may include system memory 702 in the form of read only memory (ROM) 704 and random access memory (RAM) 705. A basic input/output system (BIOS) 706 may be stored in ROM 704. System software 707 may be stored in RAM 705 including operating system software 708. Software applications 710 may also be stored in RAM 705.

The system 700 may also include a primary storage means 711 such as a magnetic hard disk drive and secondary storage means 712 such as a magnetic disc drive and an optical disc drive. The drives and their associated computer-readable media provide non-volatile storage of computer-executable instructions, data structures, program modules and other data for the system 700. Software applications may be stored on the primary and secondary storage means 711, 712 as well as the system memory 702.

The computing system 700 may operate in a networked environment using logical connections to one or more remote computers via a network adapter 716.

Input/output devices 713 can be coupled to the system either directly or through intervening I/O controllers. A user may enter commands and information into the system 700 through input devices such as a keyboard, pointing device, or other input devices (for example, microphone, joy stick, game pad, satellite dish, scanner, or the like). Output devices may include speakers, printers, etc. A display device 714 is also connected to system bus 703 via an interface, such as video adapter 715.

A medical monitoring rule recommendation may be provided as a service to a customer over a network.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method for medical monitoring rule recommendation performed by a computerized device having a processor, comprising:
indexing previously generated medical monitoring rules to provide a rules index;
determining rule features by evaluating previously generated medical monitoring rules based on existing patient data;
receiving a given patient's data;
querying the given patient's data in the rules index to provide candidate rules; and
scoring the candidate rules based on the rule features including the frequency a rule was satisfied for existing patients.

2. The method as claimed in claim 1, wherein scoring the candidate rules includes dynamic scoring based on the given patient's data by executing a candidate rule on the given patient's data.

3. The method as claimed in claim 1, wherein scoring the candidate rules includes dynamic scoring based on the given patient's data similarity to the existing patients' data of existing patients associated with a candidate rule.

4. The method as claimed in claim 1, wherein scoring the candidate rules based on the rule features includes determining a ratio of true positives and false positives of a candidate rule satisfaction.

5. The method as claimed in claim 4, including receiving user feedback on a candidate rule satisfaction in practice.

6. The method as claimed in claim 1, wherein scoring the candidate rules includes scoring based on stored medical knowledge including one of the group of: severity of a medical condition; strength of a medication.

7. The method as claimed in claim 1, wherein a medical monitoring rule includes at least one condition to be satisfied and an action to be taken if the condition is satisfied, wherein a condition includes a predicate and a value combined by a Boolean operator.

8. The method as claimed in claim 7, wherein determining rule features, determines for each predicate of a rule: the number of patients with the predicate in one or their rules; and the number of times the predicate was satisfied.

9. The method as claimed in claim 1, wherein scoring the candidate rules based on the rule features includes multiplying the predicates and scores in a candidate rule.

10. The method as claimed in claim 1, wherein the existing patient data is taken from a group of patients' data similar to the given patient's data.

11. The method as claimed in claim 1, including normalizing received given patient's data and submitting the normalized data as a query to the rules index.

12. A computer program product for medical monitoring rule recommendation, the computer program product comprising:
a computer readable non-transitory storage medium having computer readable program code embodied therewith, the computer readable program code comprising:
computer readable program code configured to:
index previously generated medical monitoring rules to provide a rules index;
determine rule features by evaluating previously generated medical monitoring rules based on existing patient data;
receive a given patient's data;
query the given patient's data in the rules index to provide candidate rules; and
score the candidate rules based on the rule features including the frequency a rule was satisfied for existing patients.

13. A system for medical monitoring rule recommendation, comprising:
a processor;
an existing rules processing component including:
a rule indexer component for indexing previously generated medical monitoring rules to provide a rules index;
a rule features component for determining rule features by evaluating previously generated medical monitoring rules based on existing patient data;
a recommendation component including:
a patient data receiving component for receiving a given patient's data;
a rule lookup component for querying the given patient's data in the rules index to provide candidate rules; and
a rule static scorer component for scoring the candidate rules based on the rule features including the frequency a rule was satisfied for existing patients.

14. The system as claimed in claim 13, wherein the recommendation component includes:
a rule dynamic scorer component for scoring the candidate rules based on the given patient's data by executing a candidate rule on the given patient's data.

15. The system as claimed in claim 13, wherein the recommendation component includes:
a knowledge scorer component for scoring the candidate rules based on stored medical knowledge including one of the group of: severity of a medical condition; strength of a medication.

16. The system as claimed in claim 15, wherein a medical monitoring rule includes at least one condition to be satisfied and an action to be taken if the condition is satisfied, wherein a condition includes a predicate and a value combined by a Boolean operator.

17. The system as claimed in claim 16, wherein the rule features component for determining rule features, determines for each predicate of a rule: the number of patients with the predicate in one or their rules; and the umber of times the predicate was satisfied.

18. The system as claimed in claim 13, wherein the rule lookup component for querying the given patient's data in the rules index includes normalizing the given patient's data and submitting the normalized data as a query to the rules index.

19. The system as claimed in claim 13, wherein the recommendation component includes:
a score aggregator component for combining the scores of the rule static scorer component, the rule dynamic scorer component, and the knowledge scorer component.

20. The system as claimed in claim 13, wherein an existing rules processing component includes:
a rule parser component for parsing the existing rules to obtain their properties.

21. The system as claimed in claim 13, including a rule feedback component for receiving user feedback on a candidate rule satisfaction in practice.

22. A method of providing a service to a customer over a network for medical monitoring rule recommendation, the service comprising:
indexing previously generated medical monitoring rules to provide a rules index;
determining rule features by evaluating previously generated medical monitoring rules based on existing patient data;
receiving a given patient's data;
querying the given patient's data in the rules index to provide candidate rules; and
scoring the candidate rules based on the rule features including the frequency a rule was satisfied for existing patients.
